(19) United States
(12) Patent Application Publication
(10) Pub. No.: US 2026/0218460 A1
(43) Pub. Date: Jul. 30, 2026

(54) CUTTING SYSTEM FOR PROFILES

(71) Applicant: GEISMAR, NEUILLY SUR SEINE (FR)

(72) Inventors: Vincent BENDRISS-TORRES, Les Aveniéres (FR); Olivier GASPARD, SAINT ONDRAS (FR); Ahmid TABTE, BRON (FR); Gérald ARAVINDAKSHAN, SEREZIN DE LA TOUR (FR)

(21) Appl. No.: 19/146,777

(22) PCT Filed: Dec. 22, 2023
(86) PCT No.: PCT/FR2023/052115

§ 371 Date: Jul. 9, 2025

(30) Foreign Application Priority Data
Jan. 9, 2023 (FR) FR23/00207

(51) Int. Cl. E01B 31/04; B23D 45/00; B23D 45/04; B23D 59/00

(52) U.S. Cl. CPC E01B 31/04; B23D 45/006; B23D 45/042; B23D 59/001

(57) ABSTRACT

A cutting system for cutting profiles, the cutting system includes a cutting machine and a support device, the cutting system varying between an assembled configuration wherein the cutting machine is secured to the support device, and a disassembled configuration wherein the cutting machine and the support device are separated, and the cutting system includes a security system.

### TECHNICAL FIELD

The invention relates to a cutting system for cutting profiles such as railway track rails, the cutting system comprising a cutting machine and a support device,
the support device being adapted to ensure, by clamping, a reversible hold of the support device on the profile intended to be cut by the cutting machine,
the cutting system varying between an assembled configuration in which the cutting machine is engaged with the support device, and a disassembled configuration in which the cutting machine and the support device are separated,
the cutting machine comprising:
   a rotatably movable cutting disc,
   an acceleration control that can be actuated by the hand of a user of the cutting system,
   a thermal energy drive motor, capable of occupying a first operational mode in which the drive motor is stopped, a second operational mode in which the drive motor is running at an idle speed, and a third operational mode in which the drive motor is running at a rotational speed strictly higher than that adopted in the second operational mode and depending on the actuation applied to the acceleration control,
   a transmission mechanism converting a rotational movement of the drive motor into a rotational movement of the cutting disc and capable of driving in rotation the cutting disc when the drive motor occupies the third operational mode,
   a control component piloting the drive motor and taking as input data representative of the actuation applied to the acceleration control.

### PRIOR ART

When cutting a given profile such as a railway track rail for example with a cutting system such as a chainsaw system, it is often necessary to manipulate the cutting machine in one direction and then in another in order to cut the profile. In fact, the cutting is done in two stages: first, the cutting disc, driven in rotation by a drive motor, ensures a cut on a first face of the rail, then, the cutting disc ensures a cut on a second face of the rail.

To achieve this, it is possible to provide an assembly mounting where the cutting machine can be flipped by pivoting relative to a support device, the latter serving to hold the profile to be cut and being able to keep a fixed position when the cutting machine pivots to cut the profile. It is also sometimes necessary to separate the cutting machine and the support device.

To avoid the risk of injury during profile cutting, a security system has already been devised to ensure that the drive motor is switched off when the cutting machine is disengaged from the support device, thereby stopping the drive motor. To achieve this, it is known to place a switch in parallel with the stop system of the drive motor. The switch therefore allows the drive motor to be stopped if the cutting machine is removed from its fastening and support device.

However, this solution is not entirely satisfactory, as it requires restarting the drive motor each time the cutting machine is separated and then reassembled on the support device. However, starting the drive motor is a time-consuming and physically demanding operation for a user of the cutting system, who must repeatedly pull a starter of the drive motor to be able to restart the drive motor.

### General Description

The aim of the invention is to provide a cutting solution for profiles such as railway rails, making it possible to overcome all or part of the aforementioned drawbacks, in particular providing both the necessary security during the profile cutting operation, while making the operation simple, ergonomic and not very time-consuming.

To this end, the present invention relates to a cutting system for cutting profiles, the cutting system comprising a cutting machine and a support device, the support device being suitable for ensuring, by clamping, a reversible hold of the support device on the profile intended to be cut by the cutting machine,
the cutting system varying between an assembled configuration in which the cutting machine is engaged with the support device, and a disassembled configuration in which the cutting machine and the support device are separated,
the cutting machine comprising:
   a rotatably movable cutting disc,
   an acceleration control that can be actuated by the hand of a user of the cutting system,
   a thermal energy drive motor, capable of occupying a first operational mode in which the drive motor is stopped, a second operational mode in which the drive motor is running at an idle speed, and a third operational mode in which the drive motor is running at a rotational speed strictly higher than that adopted in the second operational mode and depending on the actuation applied to the acceleration control,
   a transmission mechanism converting a rotational movement of the drive motor into a rotational movement of the cutting disc and capable of driving in rotation the cutting disc when the drive motor occupies the third operational mode,
   a control component piloting the drive motor and taking as input data representative of the actuation applied to the acceleration control,
the cutting system comprising a security system including a determination device capable of automatically occupying a first state as soon as the cutting system adopts the assembled configuration and of automatically occupying a second state as soon as the cutting system adopts the disassembled configuration,
the security system comprising electrical and/or software means associated with the control component configured so that from an initial configuration where the drive motor is in the second operational mode or in the third operational mode, the cutting system is selectively placed in:
   a first operating mode in which the drive motor is held by the control component in the second operational mode, the first operating mode being automatically applied when the following two conditions are simultaneously verified:
      the determination device occupies the second state,
      an absence of actuation of the acceleration control,
   a second operating mode in which the control component prohibits any transition to the third operational mode, the second operating mode being automatically applied when the following two conditions are simultaneously verified:
      the determination device occupies the second state,
      the presence of an actuation of the acceleration control.

Such a support device allows to secure and guide the cutting action of the cutting machine.

Advantageously, this security system considerably improves the comfort of use because at the time of disengagement and then re-engagement of the cutting machine to the support device, thanks to said first operating mode, the drive motor can be held running at an idle speed, preventing it from being stopped and thus avoiding any restarting of the motor which is a time-consuming and physically demanding operation for a user of the cutting system, who otherwise has to pull a starter on the motor several times. Thanks to this security system, the motor is only started once at the start of cutting. The cutting system is therefore user-friendly, practical, avoids tedious operations and allows time optimization.

In parallel with these advantages, the provided security is important because in case of the acceleration control being actuated at a time when the cutting machine is disengaged from its support device, thanks to the second operating mode, any risk of the cutting disc accelerating is inhibited due to the fact that the control component then blocks the drive motor either in the first operational mode (motor stopped), or in the second operational mode (motor idling), which implies in both cases that the disc does not rotate.

According to one characteristic, the cutting machine and the support device comprise, respectively, a first fastening element and a second fastening element of the same fastening mechanism, the assembled configuration being occupied when the first fastening element and the second fastening element cooperate with each other so that the fastening mechanism engages the cutting machine with the support device, the disassembled configuration being occupied when the first fastening element and the second fastening element do not cooperate with each other.

According to one characteristic, in the second operating mode, the drive motor is placed by the control component in the second operational mode.

According to one characteristic, in the second operating mode, the drive motor is placed by the control component in the first operational mode.

According to a non-limiting embodiment, the electrical and/or software means associated with the control component are configured so that from an initial configuration where the drive motor is in the second operational mode or in the third operational mode, the cutting system is selectively placed in:
a third operating mode in which the drive motor is placed by the control component in the third operational mode, the third operating mode being automatically applied when the following two conditions are simultaneously verified:
   the determination device occupies the first state,
   the presence of an actuation of the acceleration control,
a fourth operating mode in which the drive motor is placed by the control component in the second operational mode, the fourth operating mode being automatically applied when the following two conditions are simultaneously verified:
   the determination device occupies the first state,
   an absence of an actuation of the acceleration control.

According to one characteristic, the security system comprises a stop circuit configured to vary between an active state in which the drive motor is placed in the first or second operational mode and an inactive state in which the drive motor occupies the third operational mode, the active state prohibiting the drive motor from occupying the third operational mode.

According to one embodiment, the drive motor comprises at least one piston and at least one spark plug associated with each piston, the stop circuit being able to occupy its active state in which the electrical supply of the spark plug is inhibited or regulated for hold and its inactive state in which the electrical supply of the spark plug by the control component is authorized.

According to one embodiment, the stop circuit is placed in an electrical assembly in parallel with a main circuit including a stop switch of the drive motor separate from the acceleration control, the closing of the main circuit causing the inhibition of the electrical supply of the spark plug.

According to one characteristic, the stop circuit comprises in series:
a first switch, which occupies a first state when the disassembled configuration is adopted and which occupies a second state when the assembled configuration is adopted
a second switch varying between a first state when the acceleration control is actuated by the user's hand, and a second state when the acceleration control is not actuated,
the stop circuit occupying its active state when the following two conditions are simultaneously verified:
the first switch is in its first state,
the second switch is in its first state,
the stop circuit occupying its inactive state otherwise.

### BRIEF DESCRIPTION OF THE FIGURES

The invention will be described, by way of example only, with reference to the following figures which are not reproduced to scale and in which:

FIG. 1 is a perspective view of an example of a cutting system according to the invention and of the profile to be cut.

FIG. 2 is a partial exploded view of the cutting system of FIG. 1.

FIG. 2A is a partial exploded view showing a series of control components of a drive motor of the cutting machine in the case of a drive motor with a carburetor.

FIG. 3 is a schematic view of a first variant of a security system included in the cutting system of FIGS. 1 and 2.

FIG. 3A is a schematic view of a second variation of the security system included in the cutting system of FIGS. 1 and 2.

FIG. 4 is a flowchart which shows the operation of the cutting system.

Other technical characteristics and advantages may emerge from the detailed description that follows.

### DETAILED DESCRIPTION OF EMBODIMENTS

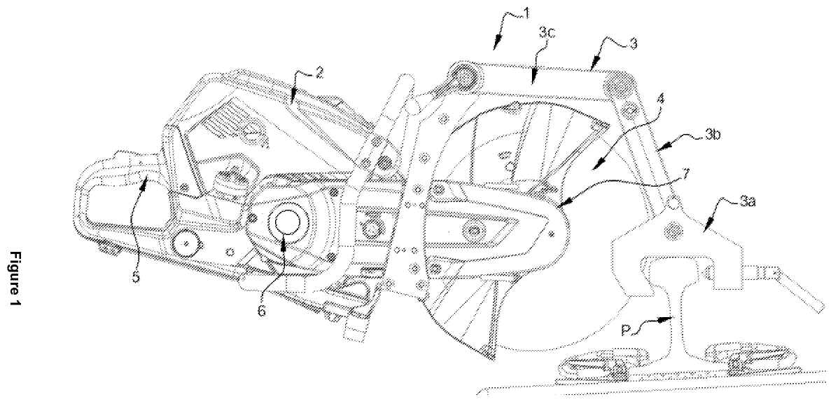

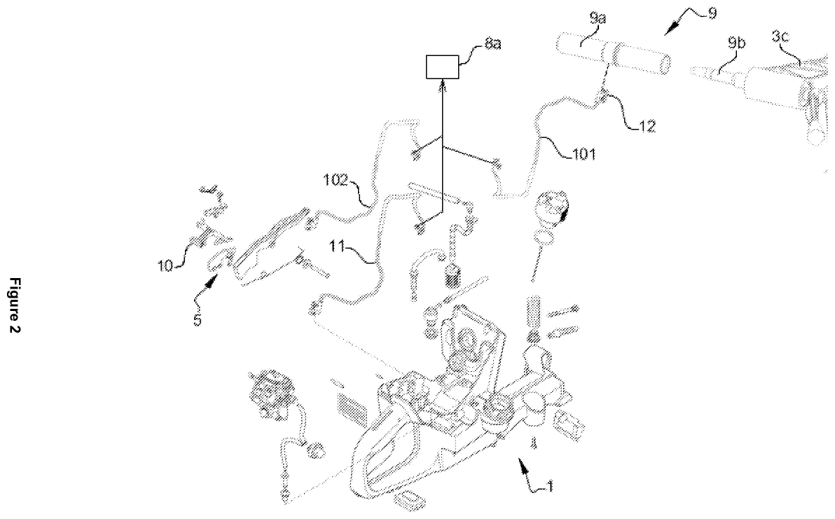

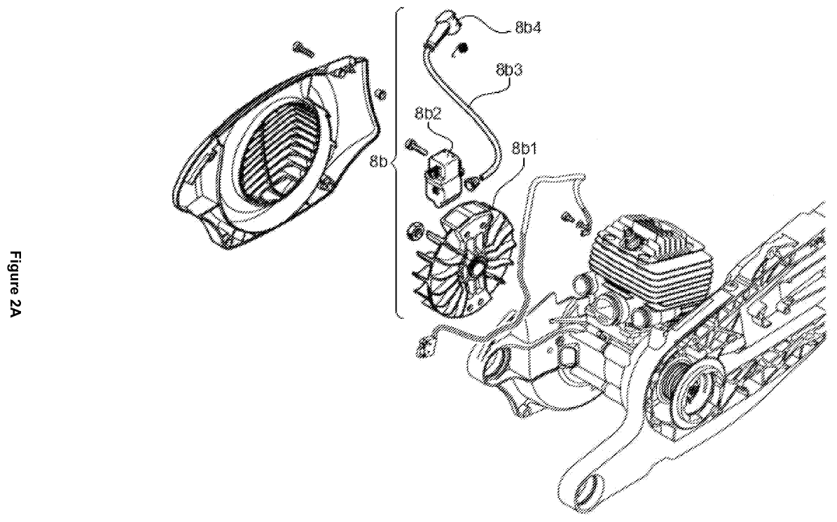

FIGS. 1 and 2 show an example of a cutting system 1 according to the invention, configured to ensure the cutting of profiles P, such as, for example and in particular, railway track rails.

The cutting system 1 comprises a cutting machine 2 and a support device 3, detailed later.

The support device 3 is adapted to ensure, by clamping, a reversible hold of the support device 3 on the profile P which is intended to be cut by the cutting machine 2.

As can be seen in FIG. 1, the cutting machine 2 comprises a cutting disc 4 rotatably movable relative to the rest of the cutting machine 2. The nature of the cutting disc 4 is not limiting as long as it is adapted to the nature of the profile P. It may be a cutting disc 4 made of metallic material or of abrasive material.

As can be seen in FIG. 1, the support device 3 comprises in this example a first support arm 3b, a second support arm 3c and a vice 3a adapted to clamp the profile P to be cut.

The vice 3a can therefore be reversibly fastened to the profile P to be cut by clamping. The nature of the vice 3a is not limiting in itself. The first support arm 3b is disposed between the vice 3a and the second support arm 3c, and the second support arm 3c is disposed between the cutting machine 2 and the first support arm 3b. As an effective example, a distal end of the first support arm 3b and a proximal end of the second support arm 3c are connected by a pivot connection, while a distal end of the second support arm 3c and the cutting machine 2 are also connected by a pivot connection. A proximal end of the first support arm 3b and the vice 3a may, for their part, possibly be connected by a pivot connection assembly. These arrangements provide great mobility of the cutting machine 2 relative to the vice 3a (and therefore relative to the profile P) in an entire plane parallel to the plane of the cutting disc 4. The support device 3 thus makes it possible to secure and guide the cutting action of the cutting machine 2.

The cutting machine 2 also comprises an acceleration control 5 capable of being actuated by the hand of a user of the cutting system 1. This control can be selected from a button placed directly on the cutting machine 2, a voice control, a wired or wireless external control, a telephone application or any other equivalent means. The acceleration control 5 incorporates a sensor (the nature of which is arbitrary here) making it possible to determine the presence and/or the intensity of the actuation applied to the acceleration control 5.

The cutting machine 2 also includes a thermal energy drive motor 6. The latter can in particular occupy:
a first operational mode in which the drive motor 6 is stopped,
a second operational mode in which the drive motor 6 is running at an idle speed,
and a third operational mode in which the drive motor 6 is running at a rotational speed strictly higher than that adopted in the second operational mode and depending on the actuation applied to the acceleration control 5.

It is specified that a clutch mechanism ensures that in the second operating mode, the cutting disc 4 is not rotatably movable even if the drive motor 6 is running.

The drive motor 6 may have one or several pistons. It may comprise a carburetor associated with the air and fuel supply of each of the pistons. The drive motor 6 may, however, be of any other type such as a turbine motor, also called a turbojet.

Optionally, the drive motor 6 may be electronically fuel-injected, in the sense that the fuel injection is then specifically regulated by dedicated electronics. Otherwise, the fuel injection is regulated based on the operation of the carburetor.

The carburetor is a mechanical component ensuring a mixture between an oxidizer (typically air) and the fuel since the drive motor 6 is of the spark ignition type (the fuel then typically being gasoline), according to an oxidizer/fuel ratio of richness adapted to the operation of the drive motor 6, allowing it to burn more or less completely in the combustion chamber associated with each piston provided. This sprayed mixture is sucked in during the intake phase. The carburetor also has the function of adjusting the rotational speed and the mechanical torque of the drive motor by modulating the filling rate. It remains optional, for example in the event that the drive motor 6 is of the electronically fuel-injected type.

The cutting machine 2 also comprises a transmission mechanism 7 converting a rotational movement of the drive motor 6 into a rotational movement of the cutting disc 4 and capable of driving in rotation the cutting disc 4 when the drive motor 6 occupies the third operational mode. The transmission mechanism 7 may for example comprise an elongated element such as a belt or a chain, connecting on the one hand the output shaft of a clutch itself coupled to the output of the drive motor 6 and on the other hand a drive pulley mounted on a transmission shaft rotatably secured to the cutting disc 4. Any other transmission system may however be used, for example using a transmission by a gear train.

The cutting machine 2 includes a control component configured to pilot the drive motor 6 and taking as input data representative of the actuation applied to the acceleration control 5.

The control component may be a component 8b associated or incorporated with the carburetor such as a switch mounted on a linkage of the carburetor for example or a series of components associated with the carburetor as in FIG. 2A where the series of components 8b comprises a magnet 8b1, a coil 8b2, a coil wire 8b3 and a suppressor 8b4.

According to another possibility, the control component may be an electronic control unit 8a.

By “pilot the drive motor 6” is meant that the control component ensures at least the placement of the drive motor 6 in the first operating mode and/or in the second operating mode and/or in the third operating mode.

The illustrated example comprises both a carburetor and an electronic control unit 8a. When the drive motor 6 is electronically fuel-injected, the electronic control unit 8a can perform the function of electronically regulating the fuel injection.

The cutting system 1 varies between an assembled configuration in which the cutting machine 2 is engaged with the support device 3 via the fastening mechanism 9, and a disassembled configuration in which the cutting machine 2 and the support device 3 are separated.

The fastening mechanism 9 comprises for example a first fastening element 9a and a second fastening element 9b respectively secured to the cutting machine 2 and to the support device 3.

The assembled configuration is occupied when the first fastening element 9a and the second fastening element 9b cooperate with each other so that the fastening mechanism 9 engages the cutting machine 2 with the support device 3. The disassembled configuration is, for its part, occupied when the first fastening element 9a and the second fastening element 9b do not cooperate with each other. For example, the assembly can be carried out by inserting a male element (which can act as the first fastening element 9a and the second fastening element 9b) into a female element (which can then act as the second fastening element 9b and the first fastening element 9a respectively), held together after insertion by screwing elements also belonging to the fastening mechanism 9. It remains that the nature of the fastening mechanism 9 is in no way limiting. For example, the assembly can be carried out by associating magnetic elements, elements having complementary half-shell shapes, or any other equivalent system.

The cutting system 1 comprises a manual stop button 10, capable of occupying a first initial natural position in which the manual stop button has no effect on the operation of the cutting machine 2, and a second position obtained by voluntary actuation by the user and in which it controls, for safety reasons, a mandatory transition of the drive motor 6 into the first operating mode independent of the other parameters or conditions taken by the other components of the cutting system 1. The manual stop button 10 may be in the form of a simple push button, a lift-type button, or a rotary button. The mode of operation of the manual stop button 10 may depend in particular on the nature of the drive motor 6 and it may act on a component of the carburetor, on the electronic control unit 8a, or directly on the electrical supply circuit of the spark plugs or on the oxidizer or fuel supply circuit. The manual stop button 10 incorporates a sensor (the nature of which is arbitrary here) making it possible to determine the presence and/or the intensity of the actuation applied to the manual stop button 10.

The cutting system 1 comprises a security system including a determination device 12 capable of automatically occupying a first state as soon as the cutting system 1 adopts the assembled configuration and of automatically occupying a second state as soon as the cutting system 1 adopts the disassembled configuration. The determination device 12 can be selected from an NC contactor, a contact sensor, a capacitive sensor, a laser sensor, or any other equivalent sensor.

The electronic control unit 8a takes as input information from the determination device 12, from the acceleration control 5 and from the manual stop button.

Advantageously, the cutting system 1 described below offers the possibility of starting the cutting machine 2 when the latter is not assembled to its support device 3. This makes it possible to gain in ergonomics and to obtain greater comfort of use.

Advantageously, the cutting system 1 makes it possible to bring up the temperature of the cutting machine 2 if necessary before placing it on the support device 3. This then saves time because, thanks to the security system described below, it becomes possible to heat up the cutting machine 2 before having access to the profile P to be cut.

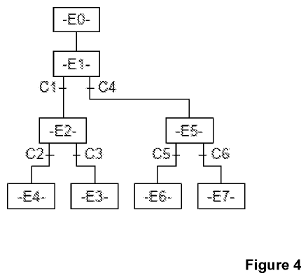

The security system comprises electrical and/or software means associated with the control component 8a, 8b, configured so that, from an initial configuration E0 (FIG. 4) where the drive motor 6 is in the second operational mode or in the third operational mode, the cutting system 1 is selectively placed in:
a first operating mode E3 (FIG. 4) in which the drive motor 6 is held by the control component 8a, 8b in the second operational mode, the first operating mode E3 being automatically applied when the following two conditions are simultaneously verified:
the determination device 12 occupies the second state,
an absence of an actuation of the acceleration control 5,
a second operating mode Ed4 (FIG. 4) in which the control component 8a, 8b prohibits any transition to the third operational mode, the second operating mode E4 being automatically applied when the following two conditions are simultaneously verified:
the determination device 12 occupies the second state,
the presence of an actuation of the acceleration control 5.

Advantageously, this security system considerably improves the user comfort because during a disengagement then a re-engagement of the cutting machine 2 on the support device 3, thanks to said first operating mode E3, the drive motor 6 can be kept running at idle speed, preventing it from being stopped and thus avoiding any restarting of the motor 6, which is a time-consuming and physically demanding operation for a user of the cutting system 1, who must otherwise pull the starter of the motor 6 several times.

Thanks to this security system, the motor is only started once at the beginning of the cut. The cutting system 1 is therefore user-friendly, practical, avoids tedious operations, and optimizes time.

Alongside these advantages, the security provided is important because in the event of manual actuation of the acceleration control 5 at a time when the cutting machine 2 is disengaged from its support device 3, thanks to the second operating mode E4, any risk of the cutting disc 4 accelerating is inhibited because the control component 8a, 8b then blocks the drive motor 6 either in the first operational mode or in the second operational mode, which means that the cutting disc 4 does not rotate in both cases.

In the second operating mode E4, the drive motor 6 may be placed by the control component 8a, 8b either in the second operational mode (particularly in the case where the electronic control unit 8a does not regulate the fuel injection) or in the first operational mode (particularly in the case where the electronic control unit 8a regulates the electronic fuel injection into the drive motor 6). In other words, in the second operating mode E4, the drive motor 6 is held in the first operational mode or in the second operational mode, which implies in both cases that the cutting disc 4 does not rotate.

According to one embodiment, the electrical and/or software means associated with the control component 8a, 8b are configured such that, from the initial configuration E0, the cutting system 1 is selectively placed in:
a third operating mode E6 (FIG. 4) in which the drive motor 6 is placed by the control component 8a, 8b in the third operational mode, the third operating mode E6 being automatically applied when the following two conditions are simultaneously verified:
   the determination device 12 occupies the first state,
   the presence of an actuation of the acceleration control 5,
a fourth operating mode E7 in which the drive motor 6 is placed by the control component 8a, 8b in the second operational mode, the fourth operating mode E7 being automatically applied when the following two conditions are simultaneously verified:
   the determination device 12 occupies the first state,
   an absence of an actuation of the acceleration control 5.

According to one embodiment, and when the control component is the electronic control unit 8a, the software means may be in the form of programmable algorithms designed and stored in a memory of the electronic control unit 8a, these algorithms being such that the electronic control unit 8a places the drive motor 6 in the first operational mode or in the second operational mode when the electronic control unit 8a simultaneously detects that:
the determination device 12 occupies the second state,
the presence of an actuation of the acceleration control 5.

To switch the drive motor 6 into the first operational mode, it is possible at any time to use the manual stop button 10, as explained previously, independently and with priority over the preceding provisions.

The following three tables summarize respectively:
the different states occupied by the determination device 12,
the different operational modes of the drive motor 6,
the different operating modes of the cutting system 1.

| State occupied by the | Configuration of the |
|---|---|
| determination device 12 | cutting system 1 |
| First state | Assembled configuration |
| Second state | Disassembled configuration |

| Operational Mode | State of the drive motor 6 |
|---|---|
| First operational mode | drive motor 6 stopped |
| Second operational mode | drive motor 6 idling |
| Third operational mode | drive motor 6 running at a rotation speed |
| | strictly higher than that adopted in the |
| | second operational mode and dependent |
| | on the actuation applied to the |
| | acceleration control 5 |

| Operating mode | State of the drive motor | Conditions to verify |
|---|---|---|
| First operating | The drive motor 6 is | The determination |
| mode E3 | held by the control | device 12 occupies |
| | component 8a, 8b in | the second state. |
| | the second operational | AND |
| | mode. | An absence of an |
| | | actuation of the |
| | | acceleration |
| | | control 5. |
| Second operating | The control component | The determination |
| mode E4 | 8a, 8b then blocks the | device 12 occupies |
| | drive motor 6 either | the second state, |
| | in the first operational | AND |
| | mode in which the | The presence of an |
| | motor is stopped, or in | actuation of the |
| | the second operational | acceleration control |
| | mode in which the | 5. |
| | motor is idling. | |
| Third operating | The drive motor 6 is | The determination |
| mode E6 | placed in the third | device 12 occupies |
| | operational mode by | the first state, |
| | the control component | AND |
| | 8a, 8b. | The presence of an |
| | | actuation of the |
| | | acceleration control |
| | | 5, |
| Fourth operating | the drive motor 6 is | the determination |
| mode E7 | placed by the control | device 12 occupies |
| | component 8a, 8b in | the first state, |
| | the second operational | AND |
| | mode | an absence of an |
| | | actuation of the |
| | | acceleration control |
| | | 5. |

The following table summarizes different possible states occupied by the cutting system 1, presenting, for each: the state assumed by the determination device 12, by the acceleration control 5, by the drive motor 6, as well as the corresponding operational mode 5 of the drive motor 6 and the state of the cutting disc 4.

| | | | | State of |
|---|---|---|---|---|
| Determination | | | Operational | the cutting |
| device 12 | Control 5 | Drive motor 6 | mode | disc 4 |
| First state | Activated | Deactivated | Third | Disc in |
| (assembled | state | stop | operational | rotation |
| configuration) | | | mode | |
| Second state | Activated | Deactivated | Second | Stopped |
| (disassembled | state | stop | operational | disc |
| configuration) | | | mode | |
| | | | OR | |
| | | | First | |
| | | | operational | |
| | | | mode | |
| First state | Deactivated | Deactivated | Second | Stopped |
| (assembled | state | stop | operational | disc |
| configuration) | | | mode | |
| Second state | Deactivated | Deactivated | Second | Stopped |
| (disassembled | state | stop | operational | disc |
| configuration) | | | mode | |
| First state | Activated | Activated | First | Stopped |
| (assembled | state | stop | operational | disc |
| configuration) | | | mode | |
| Second state | Activated | Activated | First | Stopped |
| (disassembled | state | stop | operational | disc |
| configuration) | | | mode | |
| First state | Deactivated | Activated | First | Stopped |
| (assembled | state | stop | operational | disc |
| configuration) | | | mode | |
| Second state | Deactivated | Activated | First | Stopped |
| (disassembled | state | stop | operational | disc |
| configuration) | | | mode | |

In the preceding table, the term “activated state” means that there is a manual actuation on the acceleration control 5, the term “deactivated state” means an absence of a manual actuation on the acceleration control 5, the term “activated stop” means the presence of an actuation on the manual stop button 10, and the term “deactivated stop” means the absence of an actuation on the manual stop button 10.

For example, from the preceding table, it can be seen that when the determining device 12 is in its first state (and therefore the cutting machine 2 is assembled with its support device 3), when the acceleration control 5 is actuated, when the stopping of the drive motor 6 by the manual stop button 10 is not activated, the drive motor 6 is then in its third operating mode and the cutting disc 4 is rotating, its rotation depending on the actuation applied to the control 5.

In order to constitute the electrical means mentioned above (possibly in connection with software means already mentioned), the security system may further comprise a stop circuit 14, connected to the electronic control unit 8a, configured to vary between an active state in which the drive motor 6 is placed in the first or second operational mode and an inactive state in which the drive motor 6 occupies the third operational mode, the active state preventing the drive motor 6 from occupying the third operational mode.

For example, the stop circuit 14 may be designed to perform, directly or indirectly via the electronic control unit 8a, at least one of the following actions: acting on the electronics that pilot the injection of the drive motor 6, acting on the fuel and/or oxidizer supply, acting on the exhaust by modifying its obstruction, stalling the drive motor 6 by mechanically blocking a part of the drive motor 6, for example, with a brake disc.

According to one embodiment for this purpose, and according to a possibility already indicated where the drive motor 6 can comprise at least one piston and at least one spark plug associated with each piston, the stop circuit 14 can be configured to, in its active state, prohibit the electrical supply to the spark plug (or regulate it for suitable maintenance), unlike the situation corresponding to the inactive state of the stop circuit 14 where the electrical supply to the spark plug is authorized.

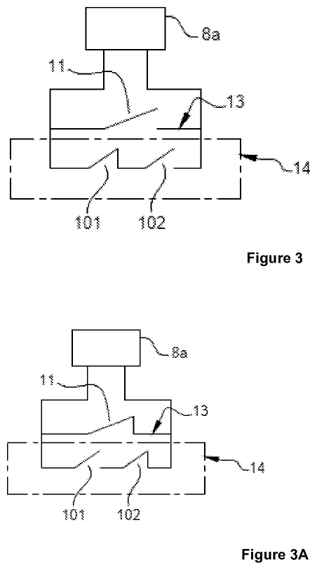

FIG. 3 illustrates an example of such a stop circuit 14, designed to act in the same way as when the manual stop button 10 is actuated for stopping. The stop circuit 14 may be placed in an electrical circuit in parallel with a main circuit 13 which includes a stop contactor 11, which stop contactor 11 is a normally open switch directly electrically piloted by the manual stop button 10 (the closed state of the stop contactor 11 being obtained when an actuation to the manual stop button 10 is present). This main circuit 13 is connected to the electronic control unit 8a, such that when the latter receives information that the stop switch is closed, the electronic control unit 8a forces the drive motor 6 to stop (for example, by inhibiting the power supply to the spark plug(s) of the drive motor 6).

As shown in FIG. 3, the stop circuit 14 may comprise in series:
a first switch 101 (for example, directly electrically connected to the determining device 12, as shown in FIG. 2), which occupies a closed state when the disassembled configuration is adopted and which occupies an open state when the assembled configuration is adopted,
a second switch 102 (for example, directly electrically connected to the acceleration control 5, as shown in FIG. 2), varying between a closed state when the acceleration control 5 is actuated by the user's hand, and an open state when the acceleration control 5 is not actuated.

Thus, it follows from the above that the stop circuit 14 occupies its active state when the following two conditions are simultaneously verified:
the first switch 101 is in its closed state,
the second switch 102 is in its closed state.

Otherwise, the stop circuit 14 occupies its inactive state. When the active state of the stop circuit 14 is occupied, the action that occurs is identical to that obtained by closing the stop contactor 11.

If the stop contactor 11 is a normally closed switch directly electrically piloted by the manual stop button 10 (the open state of the stop contactor 11 being obtained when an actuation is made to the manual stop button 10).

In this case, the electronic control unit receives the information that the stop contactor is open and forces the drive motor 6 to stop (for example, by inhibiting the power supply to the spark plug(s) of the drive motor 6).

As shown in FIG. 3A, the stop circuit 14 may comprise in series:
a first switch 101 (for example, directly electrically connected to the determination device 12, as shown in FIG. 2), which occupies an open state when the disassembled configuration is adopted and which occupies a closed state when the assembled configuration is adopted,
a second switch 102 (for example, directly electrically connected to the acceleration control 5, as shown in FIG. 2), varying between an open state when the acceleration control 5 is actuated by the user's hand, and a closed state when the acceleration control 5 is not actuated.

Thus, it follows from the above that the stop circuit 14 occupies its active state when the following two conditions are simultaneously verified:
the first switch 101 is in its open state,
the second switch 102 is in its open state.

Otherwise, the stop circuit 14 occupies its inactive state. When the active state of the stop circuit 14 is occupied, the action that occurs is identical to that obtained by opening the stop contactor 11.

However, it remains possible that the stop circuit 14 could be replaced by a control device intended to perform the same function as the stop circuit 14.

FIG. 4 shows a possible flowchart for the operation of the cutting system 1. The cutting system 1 is first in its initial configuration E0 in which the drive motor 6 is in the second operational mode or the third operational mode.

Then, in a step E1, a verification is carried out to see whether the determination device 12 occupies the second state, in other words, a verification is carried out to see whether the cutting system 1 is in its disassembled configuration.

In the case where the determination device 12 occupies the second state in step E1, then it is considered that the condition C1 is satisfied and we then move on to a step E2 in which it is verified whether the acceleration control 5 is actuated.

In the case where the acceleration control 5 is actuated, then it is considered that the condition C2 is satisfied and then we move on to the step E4 already mentioned consisting of placing the cutting system 1 in the second operating mode E4 in which the drive motor 6 is stopped or idling.

On the other hand, in the case where the acceleration control 5 is not actuated in step E2, then it is considered that the condition C3 is satisfied and then we move on to the step E3 already mentioned consisting of placing the cutting system 1 in the first operating mode E3 in which the drive motor 6 is idling.

In the case where the determination device 12 does not occupy the second state in step E1 and it appears that the determination device 12 instead occupies the first state, then it is considered that the condition C4 is verified and then we move on to a step E5 in which it is verified whether the acceleration control 5 is actuated.

In the case where the acceleration control 5 is actuated in the step E5, then it is considered that the condition C5 is satisfied and then we move on to the step E6 in which the cutting system 1 is placed in the third operating mode where the drive motor 6 is placed by the control component 8a, 8b in the third operational mode.

On the other hand, in the case where the acceleration control 5 is not actuated in the step E5, then it is considered that the condition C6 is satisfied and then we move on to the step E7, in which the cutting system 1 is placed in the fourth operating mode, where the drive motor 6 is placed by the control component 8a, 8b in the second operational mode.

In the foregoing, according to one embodiment, the steps E0 to E7 may be performed in particular by the electronic control unit 8a, with a possible action on or by the carburetor, depending on the information received by them from (or the states occupied by) the determination device 12, the acceleration control 5, and the manual stop button 10 (for example, by means of the stop contactor 11, the first switch 101, and the second switch 102 already described).

1. A cutting system suitable for cutting profiles, the cutting system comprising a cutting machine and a support device,
the support device being adapted to ensure, by clamping, a reversible hold of the support device on the profile intended to be cut by the cutting machine,
the cutting system varying between an assembled configuration in which the cutting machine is engaged with the support device, and a disassembled configuration in which the cutting machine and the support device are separated,
the cutting machine comprising:
a rotatably movable cutting disc,
an acceleration control capable of being activated by the hand of a user of the cutting system,
a thermal energy drive motor, capable of occupying a first operational mode in which the drive motor is stopped, a second operational mode in which the drive motor is running at idle speed, and a third operational mode in which the drive motor is running at a rotational speed strictly higher than that adopted in the second operational mode and depending on the actuation applied to the acceleration control,
a transmission mechanism converting a rotational movement of the drive motor into a rotational movement of the cutting disc and capable of rotatably driving the cutting disc when the drive motor occupies the third operational mode,
a control component piloting the drive motor and taking as input a data representative of the actuation applied to the acceleration control,
the cutting system comprising a security system including a determination device capable of automatically occupying a first state as soon as the cutting system adopts the assembled configuration and of automatically occupying a second state as soon as the cutting system adopts the disassembled configuration,
the security system comprising electrical and/or software means associated with the control component configured so that from an initial configuration where the drive motor is in the second operational mode or in the third operational mode, the cutting system is selectively placed in:
a first operating mode in which the drive motor is held by the control component in the second operational mode, the first operating mode being automatically applied when the following two conditions are simultaneously verified:
the determination device occupies the second state,
an absence of an actuation of the acceleration control,
a second operating mode in which the control component prohibits any transition to the third operational mode, the second operating mode being automatically applied when the following two conditions are simultaneously verified:
the determination device occupies the second state,
the presence of an actuation of the acceleration control.

2. The cutting system according to claim 1, wherein the cutting machine and the support device comprise, respectively, a first fastening element and a second fastening element of the same fastening mechanism, the assembled configuration being occupied when the first fastening element and the second fastening element cooperate with each other so that the fastening mechanism engages the cutting machine with the support device, the disassembled configuration being occupied when the first fastening element and the second fastening element do not cooperate with each other.

3. The cutting system according to claim 1, wherein in the second operating mode, the drive motor is placed by the control component in the second operational mode.

4. The cutting system according to claim 1, wherein in the second operating mode, the drive motor is placed by the control component in the first operational mode.

5. The cutting system according to claim 1, wherein the security system comprises a stop circuit configured to vary between an active state in which the drive motor is placed in the first or second operational mode and an inactive state in which the drive motor occupies the third operational mode, the active state preventing the drive motor from occupying the third operational mode.

6. The cutting system according to claim 5, wherein the stop circuit comprises in series:
a first switch, which occupies a first state when the disassembled configuration is adopted and which occupies a second state when the assembled configuration is adopted
a second switch varying between a first state when the acceleration control is actuated by the user's hand, and a second state when the acceleration control is not actuated,
the stop circuit occupying its active state when the following two conditions are simultaneously verified:
the first switch is in its first state,
the second switch is in its first state,
the stop circuit occupying its inactive state otherwise.

7. The cutting system according to claim 2, wherein in the second operating mode, the drive motor is placed by the control component in the second operational mode.

8. The cutting system according to claim 2, wherein in the second operating mode, the drive motor is placed by the control component in the first operational mode.

9. The cutting system according to claim 2, wherein the security system comprises a stop circuit configured to vary between an active state in which the drive motor is placed in the first or second operational mode and an inactive state in which the drive motor occupies the third operational mode, the active state preventing the drive motor from occupying the third operational mode.

10. The cutting system according to claim 3, wherein the security system comprises a stop circuit configured to vary between an active state in which the drive motor is placed in the first or second operational mode and an inactive state in which the drive motor occupies the third operational mode, the active state preventing the drive motor from occupying the third operational mode.

11. The cutting system according to claim 4, wherein the security system comprises a stop circuit configured to vary between an active state in which the drive motor is placed in the first or second operational mode and an inactive state in which the drive motor occupies the third operational mode, the active state preventing the drive motor from occupying the third operational mode.

12. The cutting system according to claim 7, wherein the security system comprises a stop circuit configured to vary between an active state in which the drive motor is placed in the first or second operational mode and an inactive state in which the drive motor occupies the third operational mode, the active state preventing the drive motor from occupying the third operational mode.

13. The cutting system according to claim 8, wherein the security system comprises a stop circuit configured to vary between an active state in which the drive motor is placed in the first or second operational mode and an inactive state in which the drive motor occupies the third operational mode, the active state preventing the drive motor from occupying the third operational mode.

14. The cutting system according to claim 9, wherein the stop circuit comprises in series:
a first switch, which occupies a first state when the disassembled configuration is adopted and which occupies a second state when the assembled configuration is adopted
a second switch varying between a first state when the acceleration control is actuated by the user's hand, and a second state when the acceleration control is not actuated,
the stop circuit occupying its active state when the following two conditions are simultaneously verified:
the first switch is in its first state,
the second switch is in its first state,
the stop circuit occupying its inactive state otherwise.

15. The cutting system according to claim 10, wherein the stop circuit comprises in series:
a first switch, which occupies a first state when the disassembled configuration is adopted and which occupies a second state when the assembled configuration is adopted
a second switch varying between a first state when the acceleration control is actuated by the user's hand, and a second state when the acceleration control is not actuated,
the stop circuit occupying its active state when the following two conditions are simultaneously verified:
the first switch is in its first state,
the second switch is in its first state,
the stop circuit occupying its inactive state otherwise.

16. The cutting system according to claim 11, wherein the stop circuit comprises in series:
a first switch, which occupies a first state when the disassembled configuration is adopted and which occupies a second state when the assembled configuration is adopted
a second switch varying between a first state when the acceleration control is actuated by the user's hand, and a second state when the acceleration control is not actuated,
the stop circuit occupying its active state when the following two conditions are simultaneously verified:
the first switch is in its first state,
the second switch is in its first state,
the stop circuit occupying its inactive state otherwise.

17. The cutting system according to claim 12, wherein the stop circuit comprises in series:
a first switch, which occupies a first state when the disassembled configuration is adopted and which occupies a second state when the assembled configuration is adopted
a second switch varying between a first state when the acceleration control is actuated by the user's hand, and a second state when the acceleration control is not actuated,
the stop circuit occupying its active state when the following two conditions are simultaneously verified:
the first switch is in its first state,
the second switch is in its first state,
the stop circuit occupying its inactive state otherwise.

18. The cutting system according to claim 13, wherein the stop circuit comprises in series:
a first switch, which occupies a first state when the disassembled configuration is adopted and which occupies a second state when the assembled configuration is adopted
a second switch varying between a first state when the acceleration control is actuated by the user's hand, and a second state when the acceleration control is not actuated,
the stop circuit occupying its active state when the following two conditions are simultaneously verified:
the first switch is in its first state,
the second switch is in its first state,
the stop circuit occupying its inactive state otherwise.
